(19) United States
(12) Patent Application Publication
(10) Pub. No.: US 2025/0138902 A1
(43) Pub. Date: May 1, 2025

(54) COGNITIVE-ENRICHED CONTAINER ORCHESTRATION HARDENING SYSTEM

(71) Applicant: Dell Products L.P., Round Rock, TX (US)

(72) Inventors: Werner Spolidoro Freund, Rio de Janeiro (BR); João Victor Pinto, Rio de Janeiro (BR); Micael Veríssimo de Araújo, Rio de Janeiro (BR)

(21) Appl. No.: 18/498,809

(22) Filed: Oct. 31, 2023

(51) Int. Cl. G06F 9/50; G06F 9/455

(52) U.S. Cl. CPC G06F 9/5077; G06F 9/45558; G06F 2009/45587

(57) ABSTRACT

A configuration hardening system is disclosed. A first phase collects and stores configuration structure information and threat intelligence information in a knowledge graph. A second phase receives configuration information of a container orchestration system. The configuration information is scanned for misconfigurations. Resolutions, such as patches, to the misconfigurations are determined using the knowledge graph and a human in the loop mechanism. The resolutions are applied and, when necessary, a zero trust system is provided with sufficient data to monitor the vulnerabilities or weaknesses associated with the misconfigurations. When the resolutions are ready, the resolutions, which may include updated configuration information, are implemented in the container orchestration system.

### RELATED APPLICATIONS

This application is related to U.S. Ser. No. 18/478,782 filed Sep. 29, 2023 and entitled ENHANCED CONTINUOUS MITIGATION SYSTEM THROUGH THE SURVEILLANCE OF KNOWN THREATS, which application is incorporated by reference in its entirety.

### FIELD OF THE INVENTION

Embodiments of the present invention generally relate to zero trust architectures and container orchestration. More particularly, at least some embodiments of the invention relate to systems, hardware, software, computer-readable media, and methods for hardening container orchestration systems including container orchestration configurations.

### BACKGROUND

Container orchestration generally refers to managing containers that are hosted in a computing network or infrastructure. Container orchestration includes automating aspects of container applications and container lifecycles such as provisioning, deploying, scaling, and networking. Container orchestration manages the complexity of hosting large numbers of containers, provides resilience related operations such as automatically restarting or scaling a container, and provides security. In order to protect against current attacks and unknown attacks, it is useful to continually adapt and improve security aspects of container orchestration.

Container orchestration systems often include various configuration files. Configuration files may cause a container orchestration system to be vulnerable or weak due when misconfigured. Kubescape (see armosec.io, which is incorporated by reference in its entirety) is an example of an open source tool for scanning configuration files of container orchestration systems for misconfigurations. However, the ability to identify a misconfiguration using these tools is often limited. Further, these tools do not generate fixes to the identified misconfigurations, are not capable of interacting with HITL (Human in the Loop) systems with negligible impact on scalability, and cannot feed downstream security requirements, which may be required in zero trust architectures.

More specifically, configuration settings are not typically security-oriented and this is being exploited in various cybersecurity attacks. Even if tools such as Kubescape can detect a misconfiguration, these tools are not configured to provide automated reconfigurations and are unable to identify changes for clusters, provide HITL supervision, or integrate with other security systems such as zero-trust systems.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of phases of hardening a computing system such as a container orchestration system;

FIG. 2 discloses aspects of a configuration hardening system and illustrates an example method for hardening a computing system such as a container orchestration system;

FIG. 3 discloses aspects of a knowledge graph that include semantic structure information and threat intelligence information; and

FIG. 4 discloses aspects of a computing device, system, or entity.

### DETAILED DESCRIPTION OF SOME EXAMPLE EMBODIMENTS

Embodiments of the present invention generally relate to container orchestration and zero trust architectures. More particularly, at least some embodiments of the invention relate to systems, hardware, software, computer-readable media, and methods for a configuration hardening system that can be applied or integrated with container orchestration systems and mitigate configuration weaknesses and vulnerabilities in an automated manner. Embodiments of the invention also integrate with other security systems such as zero trust systems. For example, the configuration hardening system may be configured to cooperate with a zero trust architecture when a vulnerability or weakness such as a misconfiguration cannot be remediated through a known patch.

Configuration settings can be generally described as parameters or values that may affect the functionality of a computing environment such as an infrastructure configured to host containerized applications. Many of these configuration settings are not security-oriented and misconfigurations can thus be exploited by malicious actors. For example, configuration files may be stored in various formats (e.g., YAML or JSON) and are formatted to determine or define behaviors within the container orchestration system. By way of example, a configuration file may determine how networks between containers are created and managed, define how storage volumes are mounted, determine how containers are deployed, or determine how resources are allocated. Further configuration files are used for multiple aspects of container orchestration including continuous integration/continuous delivery (CI/CD), the central control level, the operation system level, the application level, asset management level, and the like.

Embodiments of the invention relate to improving the security of container orchestration by scanning for and remediating or resolving misconfigurations in these configuration files.

In addition to scanning for misconfigurations, embodiments of the invention may provide automated reconfiguration. The process of providing automated reconfiguration may also include supervision through a human-in-the-loop (HITL) mechanism to ensure that the automatic mitigation operations (e.g., reconfiguration operations) are compliant with network specifications. In addition, embodiments of the invention ensure that any modifications made to the configuration settings of container orchestration are resilient to compromised HITL accounts. A Byzantine Fault approach may be used such that the configuration hardening system is resilient to compromised HITL accounts. This allows votes among the various HITL mechanisms or accounts to be generated to verify or authorize the configuration modifications proposed or implemented.

Embodiments of the invention are also compatible with zero trust principles such that container orchestration configuration information can be provided for downstream processing. This may be useful when, for example, a misconfiguration cannot be fixed for various reasons while allowing operation to continue. This allows the configuration hardening system and container orchestration to be integrated with zero trust architectures. Generally, zero trust architectures improve network control and security by focusing defense efforts on users, assets, and resources. A central tenet of zero trust architectures is that trust is never granted implicitly. As a result, activities of all kinds are continuously verified in zero trust architectures.

Embodiments of the invention further relate to monitoring security-centric information. In a zero trust architecture, all aspects of network activity (e.g., traffic, environment, device, application) are aggregated and stored by a security information management (SIM) system. Auditing the activity is performed by a security event management (SEM) system. Auditing often relates to threat detection and incident management or to the process of detecting exploits performed by attackers in the network and how to respond to the attacks. The SIM and SEM systems together compose a SIEM system.

A SIEM system requires observability to feed analytics tools and embodiments of the invention provide cognitive-enriched observability of container orchestration configurations to SIEM systems and enable surveillance mechanisms to be improved. An enhanced SIEM system (eSIEM), as discussed in U.S. Ser. No. 18/478,782 filed Sep. 29, 2023 and entitled ENHANCED CONTINUOUS MITIGATION SYSTEM THROUGH THE SURVEILLANCE OF KNOWN THREATS, may dedicate resources for particular vulnerabilities and weaknesses.

The capabilities of an eSIEM system includes efficiently allocating surveillance resources by dedicating just enough observability and monitoring in paths that an attacker is likely to follow. An eSIEM system can be used to harden the orchestration system and remediate the vulnerability or weakness even when a threat intelligence feed does not provide a mitigation strategy. Thus, the configuration hardening system can identify a misconfiguration or other threat and inform the SIEM system such that the vulnerability or weakness posed by the misconfiguration can be monitored effectively downstream.

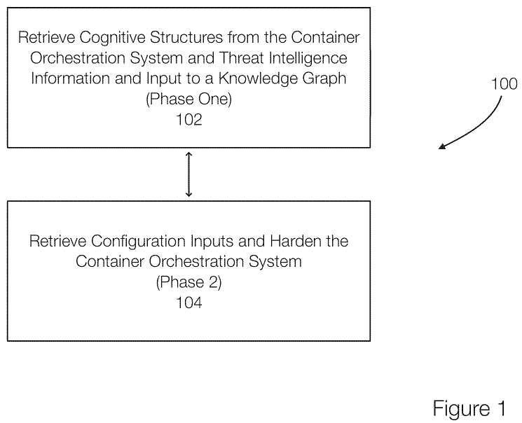

The configuration hardening system or platform may operate in at least two phases. FIG. 1 discloses aspects of these phases. The system 100 is an example of a configuration hardening system and includes two phases that may operate in sequence, simultaneously, continuously, and/or collectively. Embodiments of the system 100 are configured to harden a container orchestration system (or other computing system) in a manner that is scalable, resilient, zero-trust compliant and/or zero-trust enhancing.

Phase one of the system 100 includes retrieving 102 the cognitive structure from or associated with one or more container orchestration systems. In one example, the cognitive structure refers to the knowledge graph representation of the structure and ontological relationships of the container orchestration system configurationPhase one also include retrieving or accessing threat intelligence information and enriching the cognitive structure with the threat intelligence information. The cognitive structure and threat intelligence information may be input to a knowledge graph.

Phase 2 of the system 100 includes retrieving 104 configuration inputs and hardening those inputs, in one example, as specified by an HITL mechanism and using the information stored in the knowledge graph. Whenever a weak or vulnerable configuration (e.g., a misconfiguration) is found, the system 100 automatically generates patches whenever a known solution is available from the threat intelligence and evaluates HITL resolutions. To ensure that HITL decisions are valid and compliant to network specifications, a Byzantine Fault Tolerant (BFT) protocol may be used.

Examples of possible HITL resolutions or operation include, by way of example only:
(i) Automatically applying the patch or a modified version of the patch provided by the HITL.
(ii) Proceed as before, but under specific conditions of the input. For example, it may be determined or agreed that a patch can be automatically applied for that particular input. For example, a Boolean configuration can be automatically modified without requiring further evaluation.
(iii) Do not apply the patch and allocate dedicated SIEM resources to surveil potential exploits. The HITL mechanism may provide the surveillance strategy to avoid the exploit to the SIEM.
(iv) Ignore the particular weakness or vulnerability under particular conditions. Although no patch or dedicated SIEM resources are allocated in (iv), the configurations are still provided to the SIEM, and the SIEM may use the configurations to defend the network.

By proceeding this way, the system 100 ensures that container orchestration systems hardened configurations and the resolutions to configuration weaknesses and vulnerabilities are properly handled. The system 100 may integrate with the SIEM to be compliant with zero trust aspects by providing an observability and mitigation strategy even when the threat intelligence feed does not provide a mitigation strategy.

The system 100 allows user supervision of automated mitigation strategies, via an HITL mechanism, thereby ensuring that the automated mitigation strategies are compliant with various specifications including network specifications. User supervision allows the system 100 to be tolerant to byzantine faults (e.g., compromised accounts). Embodiments of the invention can further remediate weaknesses and vulnerabilities whose resolution is unknown using resources of efficient SIEM surveillance. Embodiments of the invention ensure that the observability of container orchestration systems is fed to improve standard SIEM surveillance as determined by zero trust architectures.

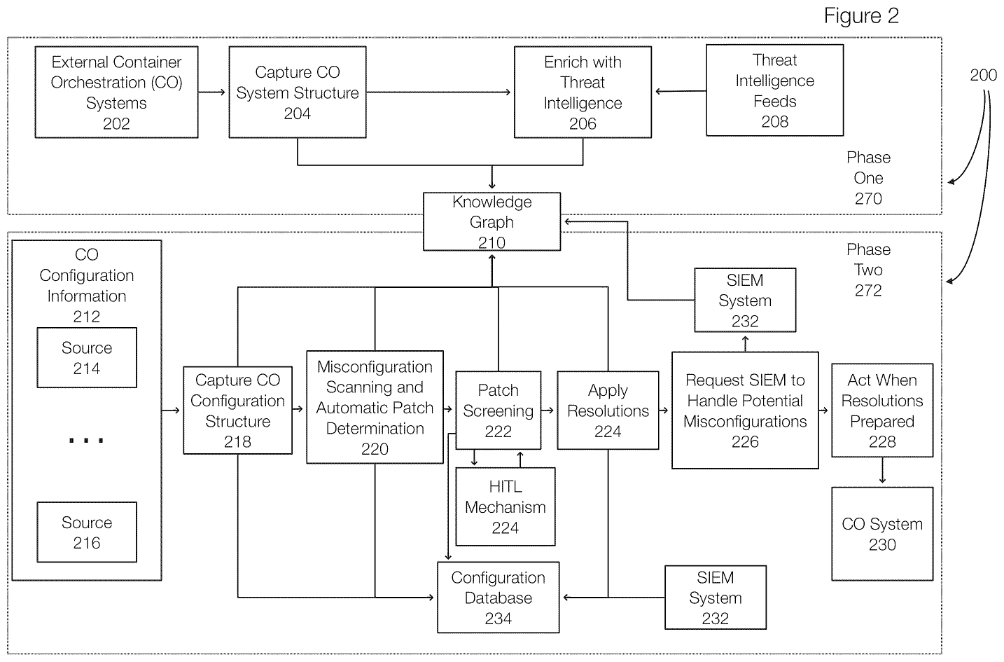

FIG. 2 discloses aspects of a configuration hardening system and illustrates an example method for hardening a computing system such as a container orchestration system. FIG. 2 illustrates a configuration hardening system 200 executing in a computing system. The computing system may also implement or be configured to execute a container orchestration system. Thus, the computing system may include the servers, nodes, memory, processors, and other hardware necessary to perform container orchestration.

The configuration hardening system 200 may execute a phase one 270 (an example of phase one 102) and a phase two 272 (an example of phase 104) that operate continually in one example. In phase one, external container orchestration (CO) information 202 is captured 204 by the configuration hardening system and stored in a knowledge graph 210 or other suitable structure. A potential example of container orchestration information could arise from the kube-api-server command and its parameters such as enable-admission-plugin option. A Knowledge Graph can be created to express its parameter description, default value and available options, which may be referred to as a semantic structure. More specifically, the container orchestration information 202 may include the semantic structure of each CO configuration mechanism and version that is subject to use and represents or stores the semantic structure of each CO system in the knowledge graph 210. The sematic structure (e.g., sysstuct) may define how configuration files are structured (fields, values, etc.) and the content.

In one example, threat intelligence feeds 208 may be available from various sources such as official kubernetes (or other container orchestration system) security announcements, blog datasets, white papers, or the like. The feeds 208 are used to enrich 206 the information captured from various CO orchestration systems 202. The enriched data is stored in the knowledge graph 210. The configuration hardening system may be configured to parse the feeds 208 into a knowledge graph representation for storage.

The threat intelligence information obtained from the feeds 208 may be added to the knowledge graph 210 with a predefined threat intelligence ontology. An example ontology is disclosed in Pinto et al, 2023. MagiKNube: Mitigating Vulnerabilities in Container Orchestration with Proper Configuration Files (OCTO-5797), which is incorporated by reference in its entirety.

The knowledge graph 210 can be complemented with semantic information that specify how the entities and relationships are governed within the database. This specification is based on ontologies and encompass elements such as classes, properties, formal naming, and the like.

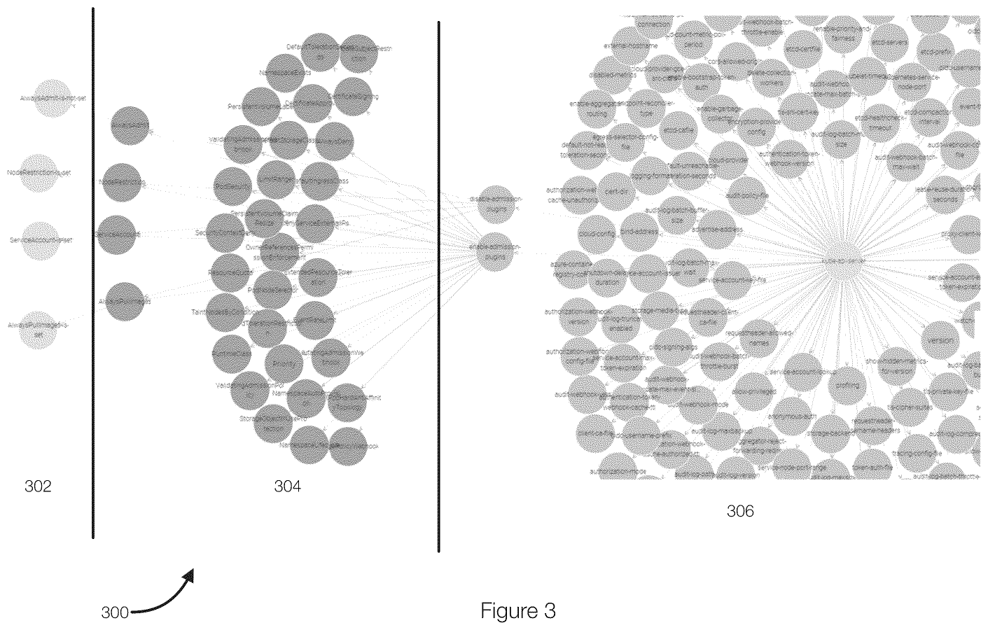

FIG. 3 illustrates an example of a knowledge graph. The knowledge graph 300, which may be an example of the knowledge graph 210, may use, by way of example, a command kube-api-server as input. This command may configure data for objects or other data that can be accessed using an API (Application Programming Interface). The knowledge graph 300 may represent arguments 306, plugins 304, and threat assessment information 302. An example knowledge graph is described in Haque et al, 2022. KGSecConfig: A Knowledge Graph Based Approach for Secured Container Orchestrator Configuration, IEEE/SANER, which is incorporated by reference in its entirety.

More generally, the knowledge graph 300 includes a conceptual representation of a fact and can be built on existing storages such as relational databases, graph databases, and stores such as triple stores. In one example, the knowledge graph 300 is flexible and can consume irregular and arbitrary data points. In one example, the knowledge graph 300 is built using a triple store. In the triple store, each activity telemetry is registered as a set of tuples in a format of (s, o, p). In this example, s stands for subject, o for object, and p for predicate. For instance, an activity of a user U aiming to invoke a CO configuration C can be registered as the tuple of triples as follows: [(U, is a, User), (C, is a CO configuration), (U, uploads, C)]. This is interpreted as a user U uploads a configuration C to a container orchestration system.

Returning to FIG. 2, phase one 270 thus operates continually in one example to update the knowledge graph 210 with CO semantic structure data or information and threat intelligence information received or acquired from the feeds 208.

Phase two 272 of the configuration hardening system 200 relates to hardening the CO configuration input and phase two 272 may operate or be triggered whenever a CO configuration input is obtained. In this example, a CO configuration 212 for a current CO system is received as input. Stated differently, the 212 CO configuration information of a container orchestration system is captured 218 or retrieved. The CO configuration information 212 may be received or acquired from various sources, represented by sources 214 and 216. Example sources may include, but are not limited to, code, continuous integration/continuous delivery/continuous deployment (e.g., CI/CD), external calls, APIs, reverse proxies intercepting communications with CO services, or the like. Kubescape is an example system that may be configured to capture configuration information. “An open-source Kubernetes security platform for your IDE, CI/CD pipelines, and clusters, 2022”, available at: https://kubescape.io, is incorporated by reference in its entirety.

If an input from an unknown CO version is retrieved, phase one 270 is triggered to retrieve the system structure for that version and the knowledge graph 210 is updated. In one example, an adapter may be installed such that the data can be acquired or converted as necessary.

Once the configuration information input is retrieved, the CO configuration information input (e.g., configuration information 212) is mapped the system representation (the semantic structure of the container orchestration system, which is stored in the configuration database 234 (and in the knowledge graph 210 in one example). Each configuration input to the configuration hardening system 200 is stored in the configuration database 234 and is associated with the corresponding network data and metadata (e.g., user, device) as determined by the SIEM system 232. Operations may be performed using the configuration database 234 such that the SIEM system 232 is aware of operations performed by the configuration hardening system and such that the SIEM system 232 is kept synchronized with current configurations.

Next, the current configuration (and/or configurations stored in the configuration database 234, are scanned 220 for vulnerabilities and weaknesses (e.g., misconfigurations) and patching possibilities. In one example, a configuration is enriched by matching the configuration information with the information stored in the knowledge graph 210 using queries. This provides implicit configurations (e.g., default parameters), potential misconfigurations and patching possibilities or other remediation options.

In one example, a patch is retrieved by following threat intelligence instructions stored in the knowledge graph 210. For example, the knowledge graph 210 may identify a location from which to retrieve a proper configuration or otherwise patch the current misconfiguration identified in the configuration information 212.

Next, patch screening 222 is performed to resolve the misconfigurations. Patches with a previous resolution defined by the HITL mechanism 224 follow the previously determined specifications. In other words, a misconfiguration corresponding to the resolution of a previous misconfiguration may be resolved in the same or similar manner. This resolution may be stored.

This behavior is achieved by ensuring that the HITL mechanism 224 informs the knowledge graph 210 after each resolution of each misconfiguration. Thus, in this example, it is only necessary to evaluate queries with the HITL resolutions associated to the particular weakness or vulnerability under evaluation in order to determine whether the patch also applies to a previous resolution.

Patches, including new patches, may be provided in an interface to the HITL mechanism 224 for appreciation. The HITL mechanism 224 may have various options. Example options include automatically applying the patch or a modified version of the patch provided by the HITL mechanism 224, not applying the patch and allocating resources of the SIEM system 232 to surveil potential exploits of the vulnerability or misconfiguration. The HITL mechanism 224 may provide the surveillance strategy to avoid the exploit and the surveillance strategy may be implemented by the SIEM system 232.

In one example, the particular weakness may be ignored under certain conditions.

In one example, the resolution provided by the HITL mechanism 224 may be obtained through a Byzantine Fault Tolerant (BFT) method. While several methods can be applied considering the specificities of the application, explicit voting is generally a sufficient approach. The HITL mechanism 224 decorates the threat intelligence information in the knowledge graph 210 with the determined resolution.

The particular conditions where the resolution applies are also provided to the knowledge graph 210. For instance, if the resolution of the HITL mechanism 224 only applies to a department D, such information is added to the resolution and the queries ensure that for a configuration C uploaded by user U, the resolution R is only appliable if the query [(C, is a, COConfig), (U is a User), (U, uploads, C), (U, department, D)] matches.

Embodiments of the invention may also segment the members or users associated with the HITL mechanisms and provide the conditions to the resolutions themselves. This may allow multiple HILT mechanisms 224 (e.g., one per business unit).

Whenever the resolution of the HITL mechanism 224 includes proceeding with a patch, the resolution is applied 236 and the entire configuration database 234 may be scanned and other matches are automatically fixed. The SIEM system 232 is requested to handle potential misconfigurations 226.

Any resolution determining to dedicate specific surveillance resources are sent to the SIEM system with the corresponding patch. The HITL mechanism 224 is expected to provide the surveillance strategy to avoid the exploit of the corresponding weakness or vulnerability. One particular embodiment is to provide a query that is applied to the container activities.

Other unhandled weaknesses and vulnerabilities with the underlying activities and their metadata are provided to the SIEM for further downstream processing. Such information can be used to facilitate alert generation and attack path discovery.

The configuration hardening system proceeds or acts 228 when resolutions are prepared and/or after the SIEM system 232 signals that enough resources are available to allocate surveillance to the new configurations (or identified misconfigurations or potential misconfigurations). The resource requirements can be estimated using the number of affected containers and the query runtime executed in a job launched in a SIEM controlled environment.

Thus, when performing or acting 228 on the resolutions, the configuration hardening system informs the CO system after all identified misconfigurations have a corresponding hardening approach prepared.

The configuration, based on the patch or other resolution, of the CO is converted from the structural representation to the format of the CO system 230 and the resolutions are performed or applied to the CO system.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, configuration operations, threat reduction operations, zero trust operations, knowledge graph operations, patch related operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection or storage functionality for one or more clients. Another example of a cloud computing environment is one in which processing, data protection, and other, services including container orchestration may be performed on behalf of one or more clients or containerized systems. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients May comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), and storage disks, for example, may likewise take the form of software, physical machines, containers, or virtual machines (VM), though no particular component implementation is required for any embodiment.

As used herein, the term ‘data’ is intended to be broad in scope. Example embodiments of the invention are applicable to any system capable of storing and handling various types of objects, in analog, digital, or other form.

It is noted with respect to the disclosed methods that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: performing a first phase of a configuration hardening system to generate a knowledge graph that stores container configuration structure information that is enriched with threat intelligence data, and performing a second phase of the configuration hardening system by: retrieving configuration information of a container orchestration system, scanning the configuration information and identifying a misconfiguration, identifying a resolution to the misconfiguration, screening the resolution with a human in the loop (HITL) mechanism, applying the resolution in accordance with an output of the HILT mechanism, and implementing the resolution in the configuration information of the container orchestration system.

Embodiment 2. The method of embodiment 1, further comprising continually performing the first phase and the second phase.

Embodiment 3. The method of embodiment 1 and/or 2, wherein the resolution is identified from the knowledge base and is included in the threat intelligence data.

Embodiment 4. The method of embodiment 1, 2, and/or 3, wherein the resolution comprises a patch.

Embodiment 5. The method of embodiment 1, 2, 3, and/or 4, further comprising performing patch screening, wherein the patch screening identifies the resolution.

Embodiment 6. The method of embodiment 1, 2, 3, 4, and/or 5, wherein the resolution is one of: automatically apply the patch of a modified version of the patch provided by the HITL mechanism, do not apply the patch and allocate resources of a zero trust system resources to surveil the container orchestration system for exploits associated with the misconfiguration, ignore a vulnerability associated with the misconfiguration without providing the patch or allocating the resources of the zero trust system, or proceed under specific conditions.

Embodiment 7. The method of embodiment 1, 2, 3, 4, 5, and/or 6, further comprising acting to implement the resolution when prepared.

Embodiment 8. The method of embodiment 1, 2, 3, 4, 5, 6, and/or 7, further comprising storing the configuration in a configuration database.

Embodiment 9. The method of embodiment 1, 2, 3, 4, 5, 6, 7, and/or 8, wherein the resolution is determined by following a byzantine fault protocol.

Embodiment 10. The method of embodiment 1, 2, 3, 4, 5, 6, 7, 8, and/or 9, further comprising retrieving the container configuration structure information and the threat intelligence data, wherein applying the resolution includes mapping the configuration to a configuration structure of the container orchestration system.

Embodiment 11 A non-transitory storage medium having stored therein instructions that are executable by one or more hardware processors to perform operations comprising the operations of any one or more of embodiments 1-10.

Embodiment 12. A system, comprising hardware and/or software, operable to perform any of the operations, methods, or processes, or any portion of any of these, disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

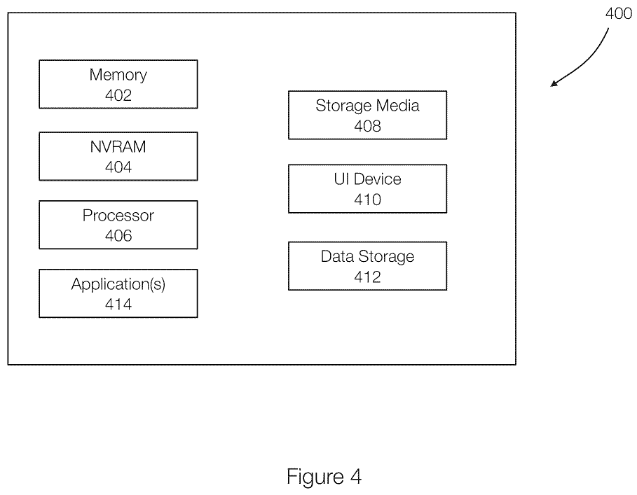

With reference briefly now to FIG. 4, any one or more of the entities disclosed, or implied, by the Figures, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 408, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein. The device 400 may represent a single device, multiple devices, a system such as an edge system or cloud system, or the like and may be physical or virtual. The device 400 may include processors, memory, and other hardware for a configuration hardening system and/or a container orchestration system.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing a first phase of a configuration hardening system to generate a knowledge graph that stores container configuration structure information that is enriched with threat intelligence data; and
performing a second phase of the configuration hardening system by:
retrieving configuration information of a container orchestration system;
scanning the configuration information and identifying a misconfiguration;
identifying a resolution to the misconfiguration;
screening the resolution with a human in the loop (HITL) mechanism;
applying the resolution in accordance with an output of the HILT mechanism; and
implementing the resolution in the configuration information of the container orchestration system.

2. The method of claim 1, further comprising continually performing the first phase and the second phase.

3. The method of claim 1, wherein the resolution is identified from the knowledge base and is included in the threat intelligence data.

4. The method of claim 3, wherein the resolution comprises a patch.

5. The method of claim 3, further comprising performing patch screening, wherein the patch screening identifies the resolution.

6. The method of claim 5, wherein the resolution is one of:
automatically apply the patch of a modified version of the patch provided by the HITL mechanism;
do not apply the patch and allocate resources of a zero trust system resources to surveil the container orchestration system for exploits associated with the misconfiguration;
ignore a vulnerability associated with the misconfiguration without providing the patch or allocating the resources of the zero trust system; or
proceed under specific conditions.

7. The method of claim 1, further comprising acting to implement the resolution when prepared.

8. The method of claim 1, further comprising storing the configuration in a configuration database.

9. The method of claim 1, wherein the resolution is determined by following a byzantine fault protocol.

10. The method of claim 1, further comprising retrieving the container configuration structure information and the threat intelligence data, wherein applying the resolution includes mapping the configuration to a configuration structure of the container orchestration system.

11. A non-transitory storage medium having stored therein instructions that are executable by one or more hardware processors to perform operations comprising:
performing a first phase of a configuration hardening system to generate a knowledge graph that stores container configuration structure information that is enriched with threat intelligence data; and
performing a second phase of the configuration hardening system by:
retrieving configuration information of a container orchestration system;
scanning the configuration information and identifying a misconfiguration;
identifying a resolution to the misconfiguration;
screening the resolution with a human in the loop (HITL) mechanism;
applying the resolution in accordance with an output of the HILT mechanism; and
implementing the resolution in the configuration information of the container orchestration system.

12. The non-transitory storage medium of claim 11, further comprising continually performing the first phase and the second phase.

13. The non-transitory storage medium of claim 11, wherein the resolution is identified from the knowledge base and is included in the threat intelligence data.

14. The non-transitory storage medium of claim 13, wherein the resolution comprises a patch.

15. The non-transitory storage medium of claim 13, further comprising performing patch screening, wherein the patch screening identifies the resolution.

16. The non-transitory storage medium of claim 15, wherein the resolution is one of:
automatically apply the patch of a modified version of the patch provided by the HITL mechanism;
do not apply the patch and allocate resources of a zero trust system resources to surveil the container orchestration system for exploits associated with the misconfiguration;
ignore a vulnerability associated with the misconfiguration without providing the patch or allocating the resources of the zero trust system; or
proceed under specific conditions.

17. The non-transitory storage medium of claim 11, further comprising acting to implement the resolution when prepared.

18. The non-transitory storage medium of claim 11, further comprising storing the configuration in a configuration database.

19. The non-transitory storage medium of claim 11, wherein the resolution is determined by following a byzantine fault protocol.

20. The non-transitory storage medium of claim 11, further comprising retrieving the container configuration structure information and the threat intelligence data, wherein applying the resolution includes mapping the configuration to a configuration structure of the container orchestration system.
